(19) United States
(12) Patent Application Publication
(10) Pub. No.: US 2016/0004617 A1
(43) Pub. Date: Jan. 7, 2016

(54) AUTOMATIC TEST PATTERN GENERATION FOR A RECONFIGURABLE INSTRUCTION CELL ARRAY

(71) Applicant: QUALCOMM Incorporated, San Diego, CA (US)

(72) Inventors: Hari Madhava Rao, San Diego, CA (US); Joseph Weizhou Fang, San Diego, CA (US); Sami Khawam, San Diego, CA (US); Ioannis Nousias, San Diego, CA (US); Raju Macha, San Diego, CA (US); Ihab Abdelmuti, San Diego, CA (US); Venugopal Boynapalli, San Marcos, CA (US)

(21) Appl. No.: 14/323,916

(22) Filed: Jul. 3, 2014

(51) Int. Cl. G06F 11/22; G06F 13/40

(52) U.S. Cl. CPC G06F 11/2289; G06F 11/221; G06F 11/2221; G06F 13/4022

(57) ABSTRACT

An instruction cell array is provided that comprises an array of tiles. Each tile includes a set of input/output (I/O) ports for switching between a plurality of input channels and a plurality of corresponding output channels. In addition, each tile includes an instruction cell comprising a plurality of dedicated logic gates for producing an instruction cell output from selected ones of the tile's input channels. Each I/O port is configured to select from the tile's instruction cell output and from the input channels for the remaining I/O ports for the tile to form the I/O port's output channels. To prevent combinatorial loops during an automatic test pattern generation (ATPG) of the array, the instruction cell array disclosed herein is configured in the testing mode such at least a subset of the I/O ports for each tile prevent any of their output channels from being formed as combinatorial signals.

### TECHNICAL FIELD

This application relates to automatic test pattern generation, and more particularly for to the automatic test pattern generation for a reconfigurable instruction cell array.

### BACKGROUND

It is generally desirable to verify any integrated circuit to detect defects that may be incurred during the manufacture process. For example, automatic test pattern generation (ATPG) is a common technique to detect faults such as stuck-at-zero or stuck-at-one faults. In an ATPG process, the device-under-test (DUT) is loaded with an input data stream (test vector) so that a resulting output vector may be analyzed accordingly. Although the use of ATPG is routine, its application to certain types of integrated circuits may be problematic.

One problematic application involves the fault testing of reconfigurable instruction cell arrays. In a reconfigurable instruction cell array (RICA), a plurality of instruction cells is interconnected through a programmable switching fabric. The configuration of the instruction cells (with regard to what sort of logical function or instruction they implement) as well as the switching fabric can be reprogrammed every clock cycle as necessary to implement a given algorithm or function. Note that an instruction cell is different from an field programmable gate array (FPGA) logic block. In particular, an FPGA logic block is “fine-grained” in that it comprises one or more lookup tables that implement the desired logic gates. But an instruction cell is much “coarser-grained” in that it contains dedicated logic gates. For example, an arithmetic logic unit (ALU) instruction cell includes assorted dedicated logic gates. It is the function of the ALU instruction cell that is configurable—its primitive logic gates are dedicated gates and thus are non-configurable. For instance, a conventional CMOS inverter is one type of dedicated logic gate. There is nothing configurable about such an inverter, it needs no configuration bits. But the instantiation of an inverter function in a FPGA programmable logic block is instead performed by a corresponding programming of a LUT's truth table. Thus, as used herein, the term “instruction cell” refers to a configurable logic element that comprises dedicated logic gates.

The instruction cells in a reconfigurable instruction cell array may be arranged by rows and columns. An instruction cell, any associated register, and an associated input and output switching fabric for the instruction cell are denoted herein as a tile. A reconfigurable instruction cell array may thus be denoted as a tile array. Each tile is configurable to route received input channels as corresponding output channels to neighboring tiles in the array. With regards to such routing, there is the possibility that combinatorial loops are created. In a combinatorial loop, the routing through the involved tiles is combinatorial—in other words, there is no registering of an output channel in a given one of the tiles as the output channel is routed to an adjacent tile in the loop. This is problematic in that an automatic test pattern generation will not finish until the combinatorial loop finishes propagating. But a combinatorial loop can continue to cycle indefinitely, which prevents an ATPG analysis from finishing.

Accordingly, there is a need in the art for reconfigurable instruction cell arrays with more robust ATPG capabilities.

### SUMMARY

An instruction cell array is provided that comprises an array of tiles. Each tile includes a set of input/output (I/O) ports for switching between a plurality of input channels and a plurality of corresponding output channels. In addition, each tile includes an instruction cell comprising a plurality of dedicated logic gates for producing an instruction cell output from selected ones of the tile's input channels. Each I/O port is configured to select from the tile's instruction cell output and from the input channels for the remaining I/O ports for the tile to form the I/O port's output channels. In a normal mode of operation, an input channel may be received in a given one of the tiles and then routed through the tile without any registration. Alternatively, the input channel may be received in the same tile and processed into an instruction cell output that in turn is routed out of the tile as an output channel without any registration. In either case, the resulting output channel is a combinatorial signal.

Although the routing of combinatorial signals as output channels is part of normal instruction cell operation, that same behavior during a testing mode of operation is problematic in that combinatorial loops through various ones of the tiles may result. The instruction cell array disclosed herein is configured in the testing mode such that at least a subset of the I/O ports for each tile prevent any of their output channels from being formed as combinatorial signals. In this fashion, an instruction cell array is provided that obviates the formation of combinatorial loops during a testing mode such as an automatic test pattern generation mode (ATPG) mode of operation.

These and other advantageous features may be better appreciated through the following detailed description.

### BRIEF DESCRIPTION OF THE DRAWINGS

FIG. 1A illustrates an array of tiles in a reconfigurable instruction cell array (RICA).

FIG. 1B is a block diagram for an individual tile.

FIG. 2 illustrates an array of tiles and the input/output ports for a selected one of the tiles in the array.

FIG. 3 illustrates a combinatorial loop in some of the tiles in the RICA of FIG. 1A.

FIG. 4 illustrates the multiplexing of registered and unregistered channels in an example tile that is robust against combinatorial loops.

FIG. 5 illustrates a tile in which all four input/output ports are robust against combinatorial loops.

FIG. 6A illustrates a first mode of operation during an ATPG analysis of an example RICA.

FIG. 6B illustrates a second mode of operation during an ATPG analysis of an example RICA.

FIG. 6C illustrates a third mode of operation during an ATPG analysis of an example RICA.

FIG. 6D illustrates a fourth mode of operation during an ATPG analysis of an example RICA.

FIG. 7A illustrates how the southeast cuts for the north periphery of a RICA are modified.

FIG. 7B illustrates how the northwest cuts for the south periphery of a RICA are modified.

FIG. 7C illustrates how the northeast cuts for the west periphery of a RICA are modified.

FIG. 7D illustrates how the southwest cuts for the east periphery of a RICA are modified.

FIG. 8 illustrates an ORing for the output channels for the corner tiles in an example RICA.

FIG. 9 is a flowchart of an example method of operation for the ATPG analysis of a RICA.

### DETAILED DESCRIPTION

Embodiments of the disclosed reconfigurable instruction cell arrays and their advantages are best understood by referring to the detailed description that follows. It should be appreciated that like reference numerals are used to identify like elements illustrated in one or more of the figures.

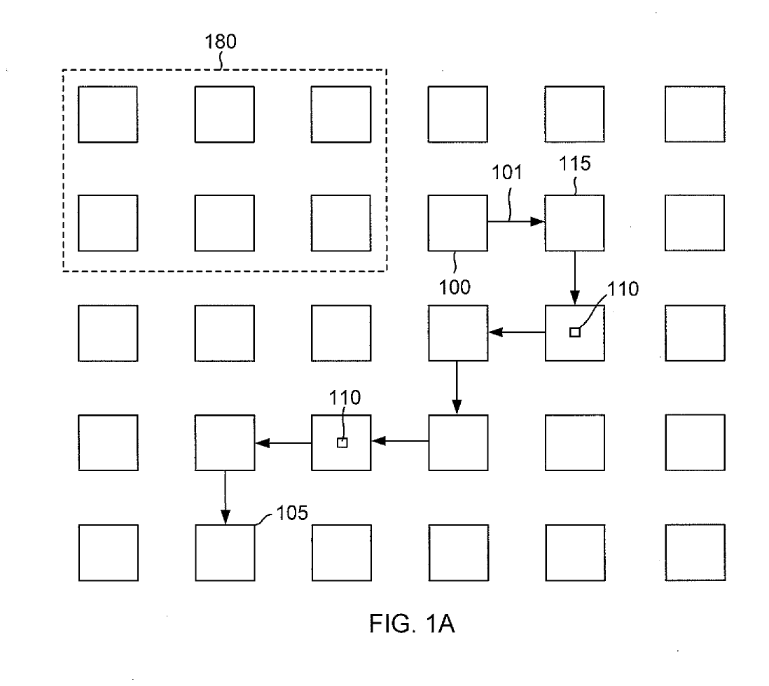

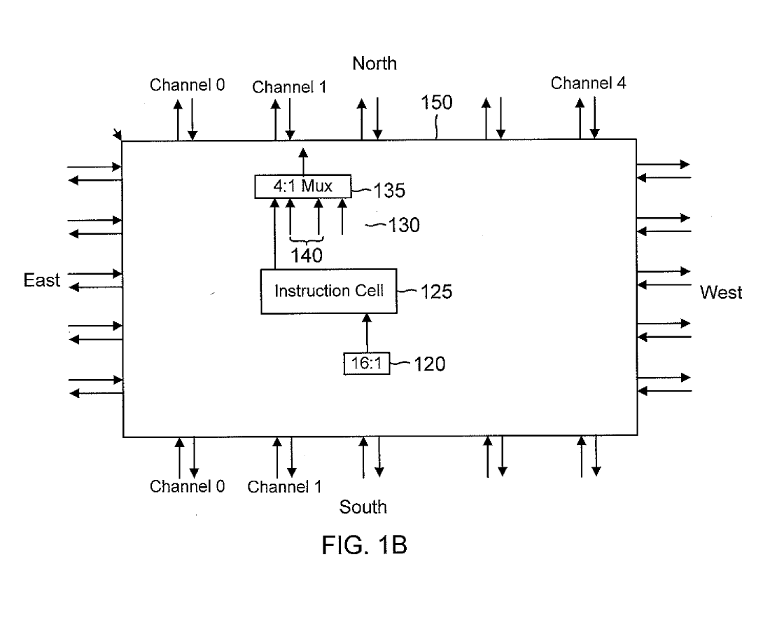

The instruction cells in a reconfigurable instruction cell array may be arranged by rows and columns. An instruction cell, any associated register, and an associated input and output switching fabric for the instruction cell are denoted herein as a tile. An instruction cell array may thus be denoted as a tile array. Turning now to the drawings, FIG. 1A illustrates an array of tiles arranged in rows and columns. A datapath formed between selected tiles is carried on channels selected from a plurality of channels. The channel routing is also arranged in rows and columns matching the rows and columns for the tiles. Each channel has a certain width in bits. The row directions may be considered to run east and west whereas the column directions run north and south.

A datapath beginning in an instruction cell in an initial tile 100 routes on an output channel 101 in an east row direction. The routing for the datapath from subsequent tiles is in the appropriate east/west row direction or north/south column direction such that a final tile 105 at some selected row and column position is reached. In this example data path, two instruction cells are configured as arithmetic logic units (ALUs) 110. The instruction cells for the remaining tiles are not shown for illustration clarity. Each tile includes two switch matrices or fabrics: an input switch fabric to select for channel inputs to its instruction cell and also an output switch fabric to select for the channel outputs from the tile.

The switch box routing within a tile may be better understood with reference to an example tile 150 shown in FIG. 1B. Tile 150 is represented by its footprint on the corresponding die. With regard to its row/column placement on the die, tile 150 may be deemed to have four sides corresponding to the north, south, east, and west directions. In this embodiment, there are five channels, ranging from a zeroth channel to a channel four in both the input and output directions. For example, on its north side, tile 150 may receive five north input channels and may drive out five corresponding north output channels. Each input and output channel comprises a plurality of conductors corresponding to the bit-width of the corresponding data words transmitted on the channels. For example, suppose the data words are 8 bits wide. In such an embodiment, each input and output channel would comprise eight conductors for carrying the eight bits in the corresponding data word.

With regard to the channel input selections for any given channel output, a 3:1 multiplexer is sufficient—for example, a north output channel may be formed by selecting from the three remaining east, west, and south input channels. Similarly, a south output channel may be formed by selecting from the north, east, and west input channels. But in a RICA embodiment such as discussed with regard to tile 150, there is also the need to select for the instruction cell output. Thus, each output conductor in a RICA embodiment for each output channel in a given tile footprint side may be driven by a 4:1 multiplexer that selects from the corresponding input channels in the 3 remaining footprint sides and an instruction cell output signal.

With regard to tile 150, there are 5 channels/side*4 sides (corresponding to the east, west, north, and south directions)*1 byte/channel=20 bytes to select from coming into tile 150. In this embodiment, an instruction cell 505 associated with tile 150 processes 4 bytes simultaneously during each clock cycle (its operands thereby being four 8-bit words). Instruction cell 505 thus receives a 32-bit wide input to produce a 32-bit wide instruction cell output. The selection of this 32-bit wide input is made with regard to channel inputs on all sides of tile 150. For example, tile 150 may include thirty-two 16:1 multiplexers 120 for this selection. An output channel for a given tile side may be formed by selecting from an instruction cell output word 130 or from the corresponding input channels 140 from the three remaining sides for tile 150. One of the corresponding input channels 140 is from the opposite cardinal direction to the given tile side. But the remaining two channel inputs 140 are selected from the orthogonal directions. Thus, the selection for each channel bit output in tile 150 may be accomplished by a 4:1 multiplexer 135. Because each channel output word is a byte wide in this embodiment, each channel output word requires eight 4:1 multiplexers 135.

The number of 4:1 multiplexers 135 depends upon the number of channels, the channel width, and the number of words processed by instruction cell 125. In the example shown in FIG. 5, there are five 8-bit output channels per each side of tile 150 that may select from four 8-bit words from instruction cell 135 such that there will thus be 8 per byte*4 bytes*5 channels=160 4:1 multiplexers 135 per each cardinal direction (each side of tile 150) for such an embodiment. The output switching fabric that is the focus of this disclosure thus concerns these multiplexers and their configuration during an ATPG analysis.

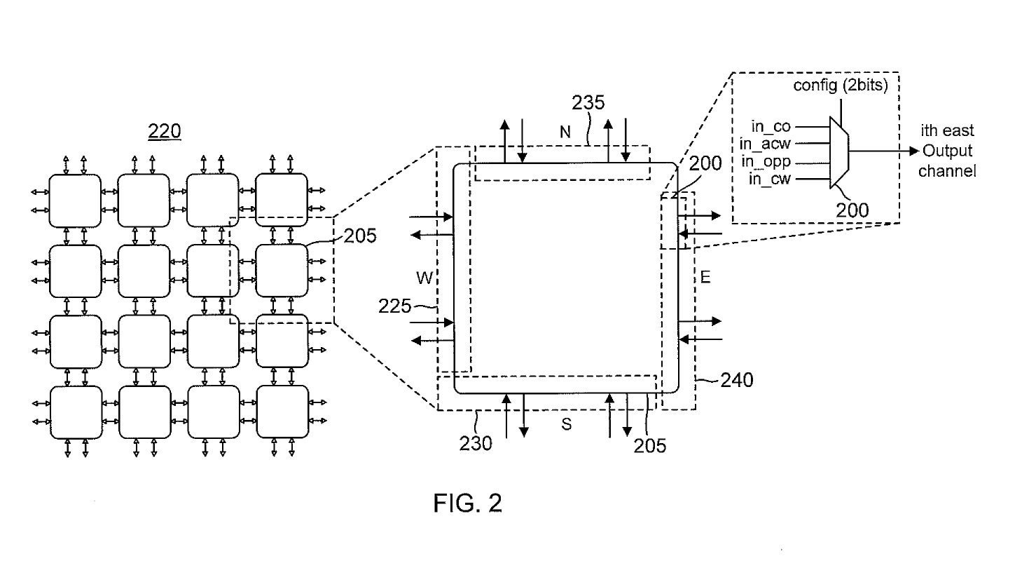

Another tile array 220 is shown in FIG. 2. For illustration clarity, there are just two input channels and two corresponding output channels for each side of the tiles in array 220. Given the north, south, east, and west routing for the input and output channels corresponding to the row and column arrangement of the tile array 220, each tile such as a tile 205 may be considered to include an input/output (I/O) port for each cardinal direction. For example, tile 205 has a west I/O port 225, a south I/O port 230, a north I/O port 235, and an east I/O port 240. At each I/O port, tile 205 receives the plurality of input channels in the corresponding cardinal direction and outputs the plurality of output channels in the corresponding cardinal direction. For example, tile 205 receives all the south input channels through south I/O port 230. Similarly, tile 205 drives all the south output channels through south I/O port 230. Each I/O port thus comprises the output switch fabric for driving the I/O port's output channels.

With regard to each I/O port, the output channels are selected for by corresponding channel output multiplexers. Each output channel thus has its own corresponding channel output multiplexer at any given I/O port. For illustration clarity, only a single channel output multiplexer 200 is shown for an east output channel for east I/O port 240 in tile 205. This channel will be designated as the ith east output channel in that the particular channel “i” it represents is arbitrary. Additional east output channels would be provided by analogous channel output multiplexers. Similarly, the north, south, and west output channels would also be selected for by their own corresponding channel output multiplexers. The resulting set of I/O ports 225, 230, 235, and 240 (each one comprising a plurality of channel output multiplexers) makes up the output switch fabric for tile 205. With regard to any particular output channel driven out of a given I/O port, the corresponding channel output multiplexer may be configured to select for the same input channel received by the I/O port in the opposite direction. For example, an ‘ith” west output channel may be driven by the ith east input channel, where i is some arbitrary channel number. Similarly, an ith north output channel may be driven by an ith south input channel and so on.

Since channel output multiplexer 200 is driving the ith east output channel, it receives an “in_opp” input channel that corresponds to the west input channel for channel i. The in_opp input may also be referred to as the opposite input. Each channel output multiplexer may also select from input channels received at the I/O ports in the orthogonal directions. In other words, the channel output multiplexer for a west output channel may select from an input channel in the north and south directions. Similarly, the channel output multiplexer for a north output channel may select from the input channels in the east and west directions. In that regard, the orthogonality for such a selection may be denoted as being either clockwise or anti-clockwise with regard to the output direction for a channel output multiplexer. For example, from the perspective of channel output multiplexer 200, it is an anti-clockwise rotation to select from a north input channel. Similarly, it is a clockwise rotation to select from a south input channel for channel output multiplexer 200. Thus each channel output multiplexer in the I/O ports in tile 200 can select from a clockwise (in_cw) input channel and also from an anti-clockwise (in_acw) input channel. In addition, each channel output multiplexer can also select the instruction cell output word (in_co) to drive its output channel.

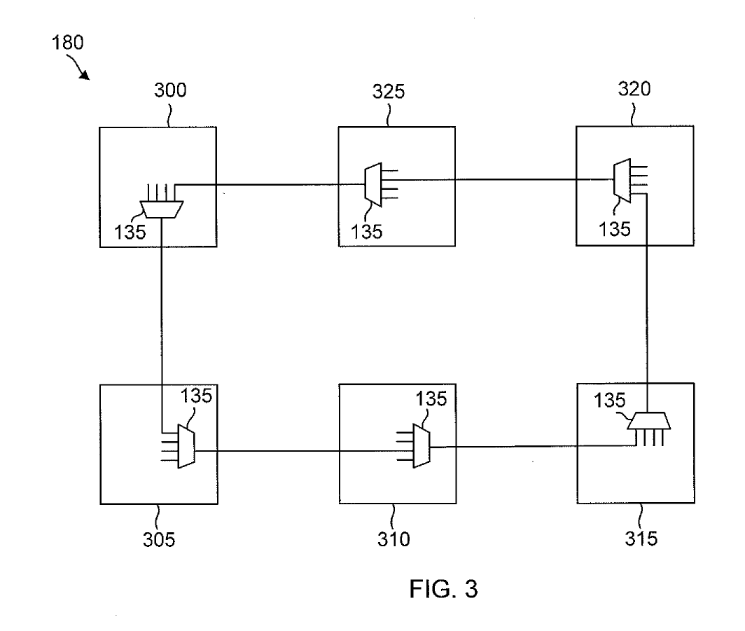

As will be explained further, only a subset of the channels in each tile may be registered in one embodiment. In alternate embodiments, every output channel may be registered in every tile. The following discussion will address an embodiment in which just a subset of the output channels may be registered without loss of generality. Even if a tile is configured to have the capability to register a given output channel, such a tile will also have the capability to bypass the registration for that output channel. So all output channels may be combinatorial regardless of whether a tile may register a given output channel or not. This ability to form combinatorial paths from one tile to another in the routing of a channel (a data word) through the tile array can be problematic. For example, consider FIG. 3, which shows a sub-array 180 of tiles from the array in FIG. 1A. In FIG. 3, these adjacent tiles are labeled as tiles 300, 305, 310, 315, 320, and 325. Each tile includes a 4:1 channel output multiplexer 135 that selects for the corresponding output channel that is illustrated as being routed from tile to tile in sub-array 180. Multiplexers 135 form a combinatorial loop that causes an ATPG analysis to hang or run indefinitely as it waits for a sequential result from this loop, which will never happen.

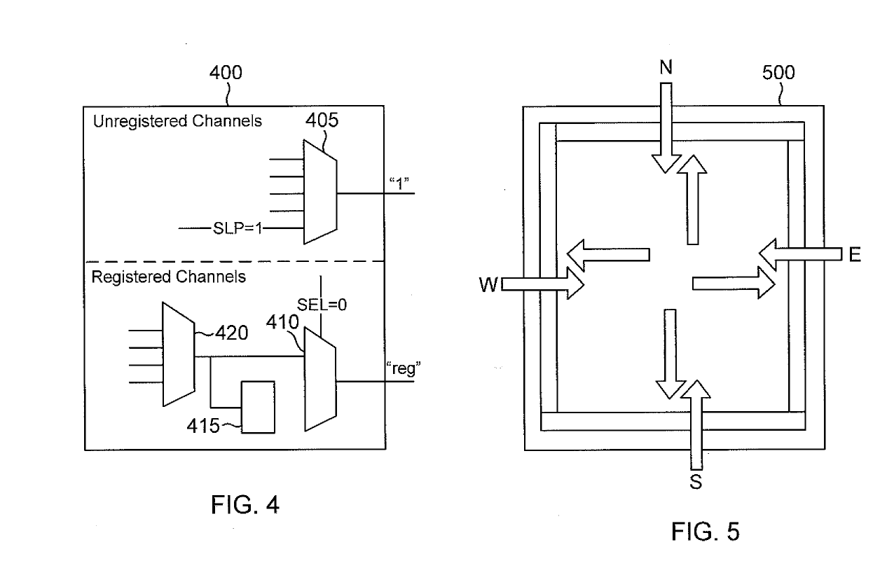

The improved architecture disclosed herein configures the output multiplexers in an instruction cell array switching fabric so as to eliminate the possibility of combinatorial loops. An example tile 400 is shown in FIG. 4. A channel output multiplexer 405 selects for an output channel that does not have the capability of being registered in tile 400. Output multiplexer 405 is also a 4:1 multiplexer in that it can select from the opposite, clockwise, and counter-clockwise input channels as well as the instruction cell output. But output multiplexer 405 can also be forced in an ATPG test mode to drive its output channel into a known logical state such as all logical ones. The 4:1 multiplexer is thus pictured conceptually as a 5:1 mux in that it can also select for the all logical ones output. But it will be appreciated that there is no such 5^{th} input to multiplexer 405, it is still a 4:1 multiplexer but it is configurable to drive its output channel into a known logic state.

An output multiplexer 420 for the registered channel is also a 4:1 multiplexer as discussed above. However, output multiplexer 420 drives both a register 415 and a 2:1 multiplexer 410. The 2:1 multiplexer 410 can then select from either the output of 4:1 multiplexer 420 or a registered output from the register 415. In the ATPG test mode, the 2:1 multiplexer 410 is forced to select for the registered output from register 415.

The adaptations to the registered and unregistered channels shown in FIG. 4 may be applied to all four sides of a tile. In that case, input channels (and also the instruction cell output) in the ATPG test mode for such a tile can never be output channels as shown for a tile 500 of FIG. 5. As shown in tile 500, the input channels in all the cardinal directions may be received but cannot pass out of tile 500 as output channels. Tile 500 may be designated as a “4 cut” tile in that the four I/O ports corresponding to the four cardinal directions are cut off from being able to drive an output channel with a received input channel or an instruction word output. Although a 4-cut tile can never be part of a combinatorial loop, one can immediately appreciate that not all the tiles could have all four sides shut down in this fashion—one needs to test for the ability of one tile to drive the input channel of a neighboring tile as this is part of normal array function. But consider the danger if two neighboring tiles without any cuts are tested during an ATPG mode: for example, suppose two tiles neighbor each other on the same row: one to the east and another to the west. The tile on the west side could drive an east output channel that would be received as a west input by the eastern tile. That receiving tile could then drive its instruction cell with the received channel to produce an instruction word output that could then be driven back to the west tile as a west output channel. Two neighboring tiles could thus “ping-pong” a combinatorial output to each other in this fashion so as to form a combinatorial loop.

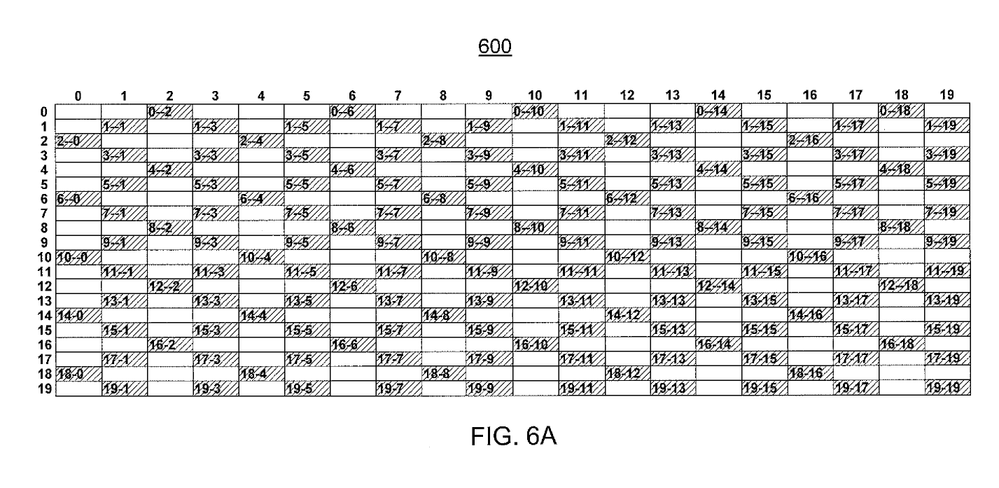

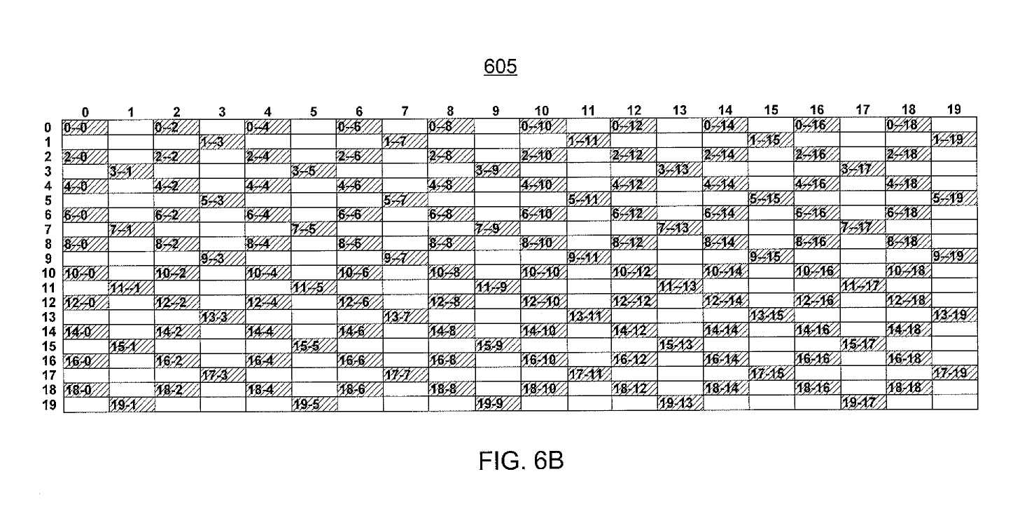

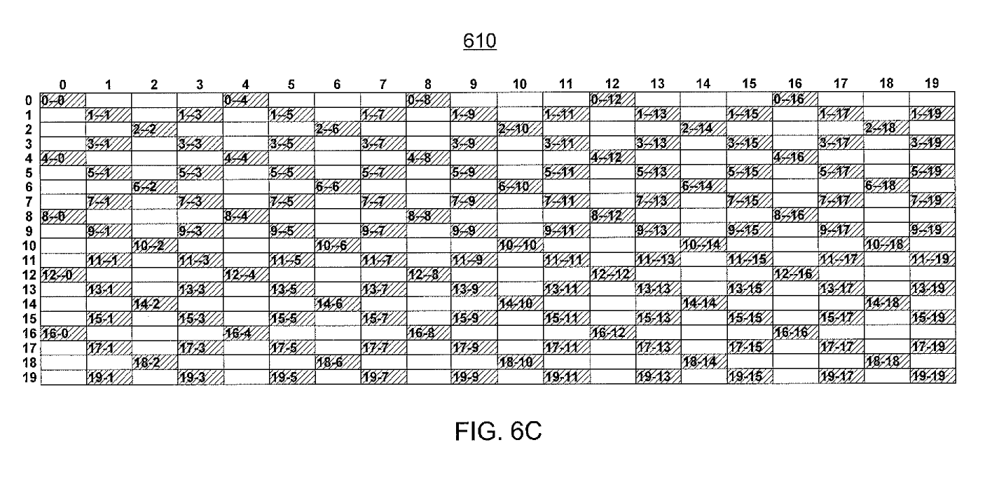

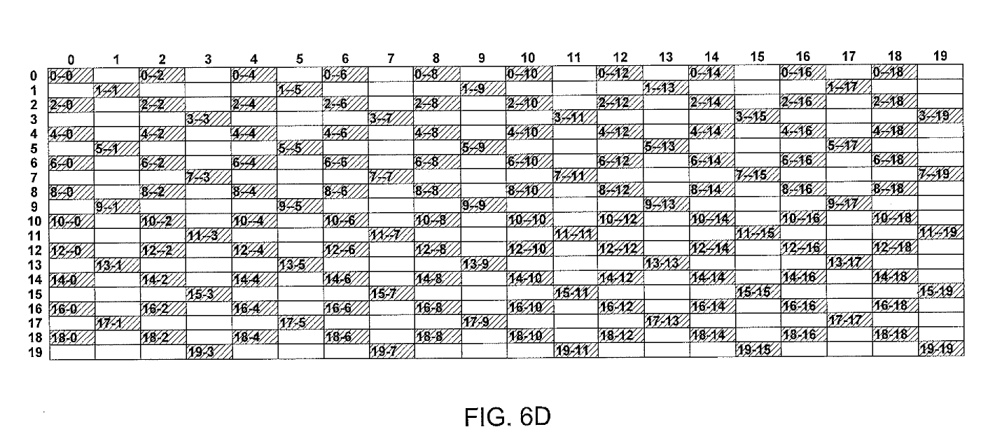

To eliminate this danger, each tile in an ATPG test mode as disclosed herein has at least two cut sides. As used herein, a “cut side” refers to an I/O port that is configured in a testing mode to be unable to drive any input channel or an instruction word output out of the I/O port as an output channel. To prevent the formation of combinatorial loops, tiles with four cut sides may be arranged throughout the array in a lattice-like or diamond-shaped configuration. A first lattice configuration 600 for an ATPG test mode of operation is shown in FIG. 6A. Each cross-hatched tile has all four sides cuts whereas the remaining tiles have at least two side cuts but not all four sides cut. Although combinatorial loops are thus thwarted, note that there is not a complete testing of the four-cut tiles in that these tiles cannot route out combinatorial signals. In lattice configuration 600, column 0 has every 4^{th} tile as a 4-cut tile, starting row 2. In column 1, every other tile is a 4-cut tile, stating from row 1. This pattern for column 1 is repeated for every 2^{nd} consecutive column from column 1. In other words, column 3 has the same pattern, column 5 has the same pattern, and so on. With regard to column 0, the every-4^{th}-tile-being-a-4-cut-tile pattern is also repeated for every 2^{nd} consecutive column from column 0 but is shifted up by two rows. For example, column 2 is like column 0 but the every-4^{th}-tile pattern is shifted by two rows.

To allow for the testing of these cells, a variety of other testing patterns may be used such as shown in FIGS. 6B, 6C, and 6D for lattice configurations 605, 610, and 615, respectively. In lattice configurations 605 and 610, it is column 0 that has every 2^{nd} tile be a 4-cut tile. In lattice configuration 610, it is again column 1 that has every 2^{nd} tile be a 4-cut tile. With regard to the non-cross-hatched tiles having at least two cut sides, it greatly simplifies the design and testing if the same two sides are cut in each of these tiles. For example, if the north and west sides are cut, such a configuration may be referred to as a northwest cut. Similarly, if the north and east sides are cut, the corresponding configuration may be referred to a northeast cut and so for the remaining southeast and southwest configurations. But there is a slight complication in that for each of these two-cut possibilities, one of the peripheries for the array will then have the possibility of a combinatorial loop.

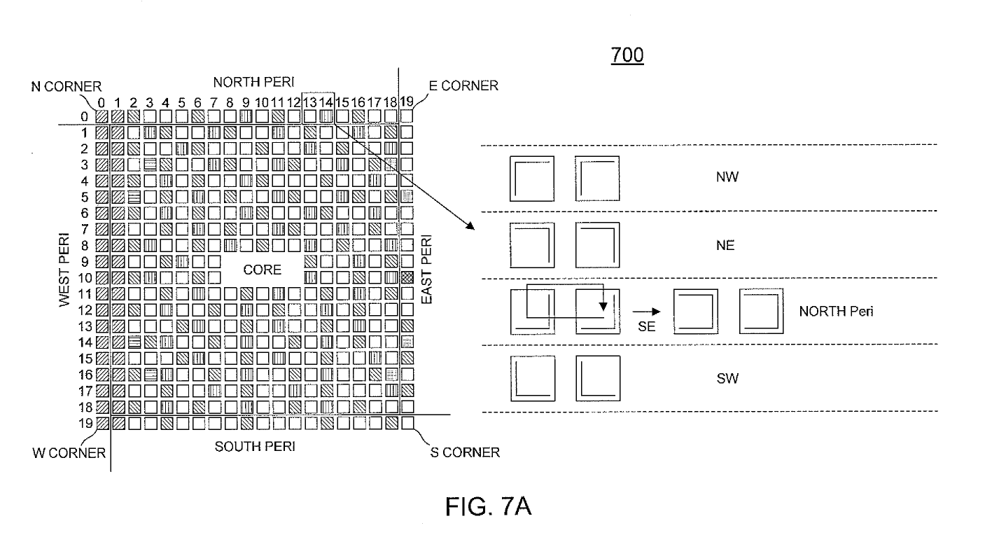

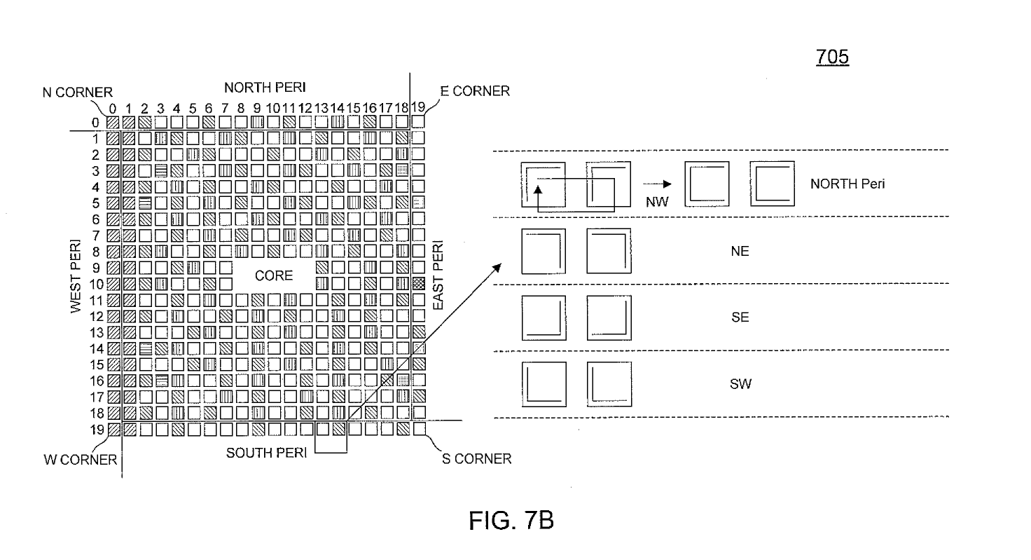

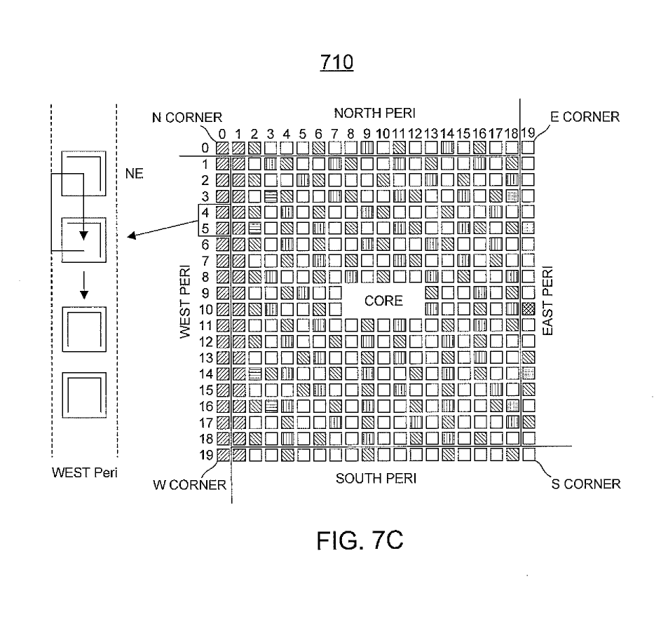

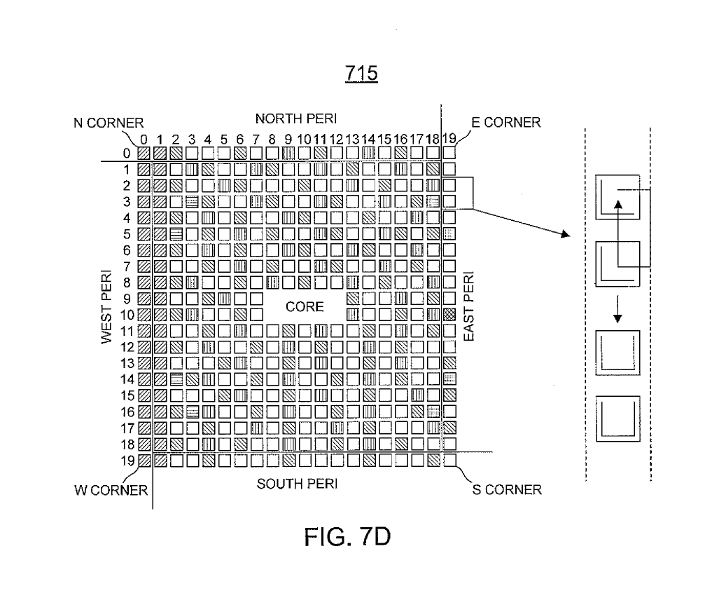

For example, consider the north periphery for an array 700 shown in FIG. 7A. If a southeast configuration is used for the two-cut tiles in array 700, a combinatorial loop may be formed between adjacent tiles in columns 13 and 14 on the north periphery of array 700 as shown. To guard against this possibility when a southeast two-cut configuration is selected, all north periphery two-cut tiles in array 700 are instead modified to have not only the south and east sides cut but also the north side. Similarly, consider an array 705 shown in FIG. 7B. If a northwest cut is used for the two-cut tiles, adjacent south periphery tiles may form a combinatorial loop as shown for columns 13 and 14 (note that these columns are merely examples and that the same combinatorial loop could be formed in any two consecutive north-west-cut south periphery tiles). To guard against this possibility, the south periphery two-cut tiles not only have their north and west sides cut for a northwest 2-cut configuration but also have their south sides cut.

It will thus be appreciated that for a two-cut northeast configuration as shown for an array 710 in FIG. 7C, the west periphery tiles will also need their west sides cut. Similarly, for a two-cut southwest configuration as shown in FIG. 7D for an array 715, the east periphery tiles will also need their east sides cut in a southwest two-cut configuration.

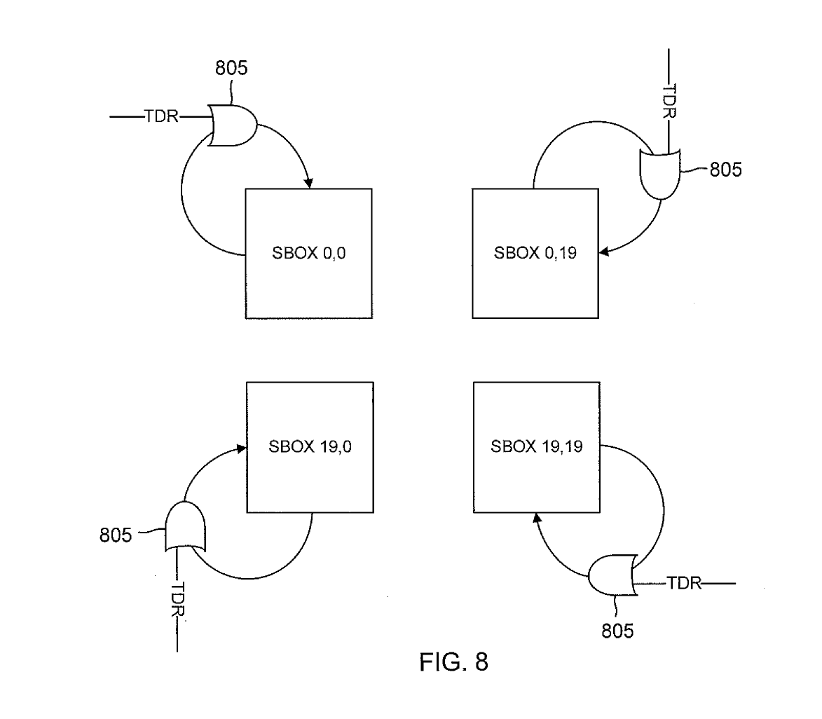

Note that the four corner tiles in an array may form an “internal” combinatorial loop. For example, a west output channel for the tile in the northwest corner of the array may be routed back into the same tile as a north input channel. To prevent this possible combinatorial loop, the output channels for the four corner tiles that may be routed back to the same corner tile have their combinatorial loops broken through a logic gate such as NOR gates 805 as shown in FIG. 8. Each NOR gate 805 also receives a testing mode signal (TDR) that is asserted in the testing mode to prevent a combinatorial signal from propagating through NOR gate 805. An example method of operation for an instruction cell array will now be discussed that eliminates the problem of combinatorial loops during an ATPG mode of operation.

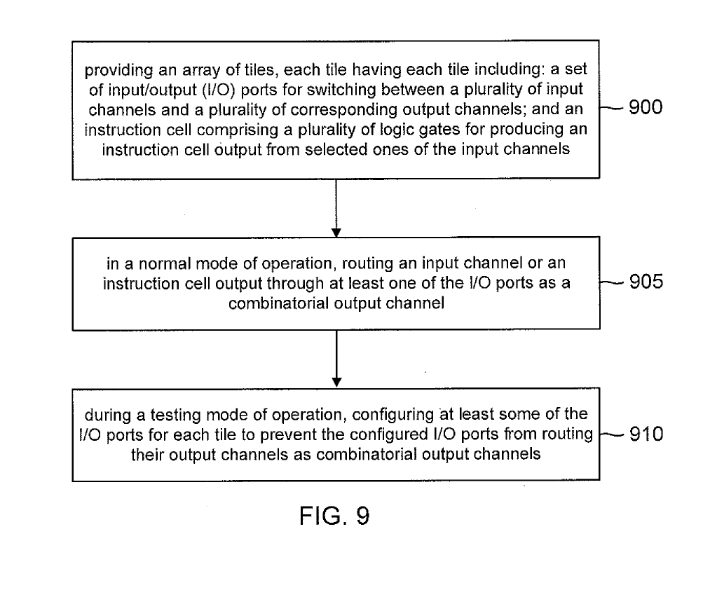

FIG. 9 is a flowchart for an example method of operation for an instruction cell array. The method includes an act 900 of providing an array of tiles, each tile having each tile including: a set of input/output (I/O) ports for switching between a plurality of input channels and a plurality of corresponding output channels; and an instruction cell comprising a plurality of logic gates for producing an instruction cell output from selected ones of the input channels. The provision of array 220 of FIG. 2 is an example of act 900. The method further includes an act 905 of, in a normal mode of operation, routing an input channel or an instruction cell output through at least one of the I/O ports as a combinatorial output channel. The selection of a combinatorial output channel in multiplexer 200 of FIG. 2 is an example of act 905. Finally, the method also includes an act 910 of, during a testing mode of operation, configuring at least some of the I/O ports for each tile to prevent the configured I/O ports from routing their output channels as combinatorial output channels. The configuration of the four output ports as shown for a tile 500 in FIG. 5 is an example of act 910.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

We claim:

1. An array, comprising:
a plurality of tiles, each tile including:
a set of input/output (I/O) ports for switching between a plurality of input channels and a plurality of corresponding output channels; and
an instruction cell comprising a plurality of logic gates for producing an instruction cell output from selected ones of the input channels;
wherein each I/O port is configured to select from the instruction cell output and from the input channels for the remaining I/O ports to form the I/O port's output channels, and wherein a subset of the I/O ports are configured in a testing mode to prevent any of their output channels from being combinatorial signals.

2. The array of claim 1, wherein each I/O port includes:
a plurality of first multiplexers corresponding to the I/O port's plurality of output channels; each first multiplexer being configured in a normal mode of operation to select from the I/O port's tile's instruction cell output and from the corresponding input channel from each of the remaining I/O ports in the I/O port's tile to form an output signal
a plurality of second multiplexers corresponding to a first subset of the output channels; and
a plurality of registers corresponding to the first subset of the output channels, each register being configured to register the output signal from the corresponding first multiplexer, wherein each second multiplexer is configured to select between the output signal from the corresponding first multiplexer and the registered output signal from the corresponding register to form the corresponding output channel, and wherein each second multiplexer is configured to select for the registered output signal in the testing mode.

3. The array of claim 2, wherein the first subset of the output channels comprises all of the output channels.

4. The array of claim 2, wherein the plurality of the output channels comprises the first subset of the output channels and a second subset of the output channels, wherein each first multiplexer corresponding to an output channel in the second subset is configured to drive its output signal as the corresponding output channel, and wherein each first multiplexer corresponding to an output channel in the second subset is further configured in the testing mode to drive its corresponding output channel into a predetermined binary state.

5. The array of claim 1, wherein set of I/O ports for each tile comprises four I/O ports.

6. The array of claim 5, wherein a first subset of the tiles in the testing mode are configured to have all four of their I/O ports configured to prevent any of their output channels from being combinatorial signals.

7. The array of claim 5, wherein a remaining second subset of the tiles are each configured to have at least one of their I/O ports not configured to prevent any of their output channels from being combinatorial signals.

8. The array of claim 1, wherein the instruction cell for at least some of the tiles is configured as an arithmetic logic unit.

9. A method, comprising:
providing an array of tiles, each tile including: a set of input/output (I/O) ports for switching between a plurality of input channels and a plurality of corresponding output channels; and an instruction cell comprising a plurality of logic gates for producing an instruction cell output from selected ones of the input channels;
in a normal mode of operation, routing an input channel or an instruction cell output through at least one of the I/O ports as a combinatorial output channel; and
during a testing mode of operation, configuring at least some of the I/O ports for each tile to prevent the configured I/O ports from routing their output channels as combinatorial output channels.

10. The method of claim 9, wherein during the testing mode of operation, configuring at some of the I/O ports comprises configuring all of the I/O ports for a first subset of the tiles.

11. The method of claim 10, wherein providing the array of tiles comprises providing an array of tiles each having four I/O ports, and wherein during the testing mode of operation, configuring at least some of the I/O ports comprises configuring less than each of the four I/O ports for a remaining second subset of the tiles.

12. The method of claim 10, wherein during the testing mode of operation, configuring all of the I/O ports for a first subset of the tiles comprises arranging the first subset of the tiles to form a lattice-shaped pattern through the array.

13. The method of claim 12, further comprising shifting the arrangement of the lattice-shaped pattern through the array during the testing mode of operation.

14. The method of claim 10, wherein the testing mode of operation comprises an automatic test pattern generation (ATPG) mode.

15. The method of claim 10, wherein providing the array of tiles comprises providing an array of tiles arranged into rows and columns.

16. An instruction cell array, comprising:
an array of four-sided tiles, each tile including an input/output (I/O) port for each side and an instruction cell comprising a plurality of dedicated logic gates, wherein the array of tiles is configured in a normal mode of operation such that each I/O port for a given tile may drive output channels that are received as input channels to a neighboring tile's I/O port, and wherein the array of tiles is configured in a testing mode of operation to prevent the formation of combinatorial loops.

17. The instruction cell array of claim 16, wherein at least some of the instruction cells comprise arithmetic logic units.

18. The instruction cell array of claim 16, wherein each I/O port is configured to drive a plurality of output channels through a corresponding plurality of first multiplexers.

19. The instruction cell array of claim 18, wherein each first multiplexer is a 4:1 multiplexers.

20. The instruction cell array of claim 18, wherein each I/O port includes a plurality of registers corresponding to at least a subset of the output channels.
